(19) United States
(12) Patent Application Publication
(10) Pub. No.: US 2019/0384199 A1
(43) Pub. Date: Dec. 19, 2019

(54) Toner with Controlled Wax Dispersion

(71) Applicant: Lexmark International, Inc., Lexington, KY (US)

(72) Inventors: Ann P. Holloway, Lexington, KY (US); Rudolph Wayne Hrobsky, Platteville, CO (US); Michael Gordon Miller, Longmont, CO (US); James Craig Minor, Niwot, CO (US); Dinesh Tyagi, Mead, CO (US)

(21) Appl. No.: 16/441,502

(22) Filed: Jun. 14, 2019

Related U.S. Application Data
(60) Provisional application No. 62/687,137, filed on Jun. 19, 2018.

(51) Int. Cl. G03G 9/087; G03G 9/09

(52) U.S. Cl. CPC G03G 9/08755; G03G 9/0904; G03G 9/08782

(57) ABSTRACT

A toner composition includes low and high molecular weight polyester resins. It also includes a release agent, such as a polyolefin wax, and a tri-block copolymer having a structure of the form A-b-B-b-A, wherein A is a hard block and B is a soft block. The hard block is styrene, while the soft block is butadiene/butylene. Upon partial hydrogenation, the copolymer provides improved dispersion, mobility control, and domain size of the release agent.

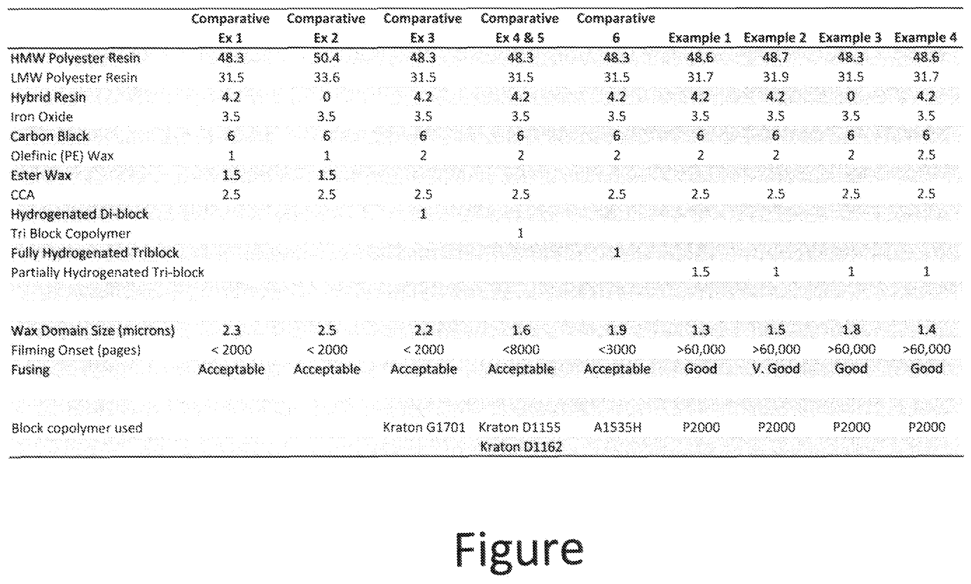

This application claims priority from provisional patent application Ser. No. 62/687,137, filed Jun. 19, 2018, entitled Toners with Controlled Wax Dispersion, whose contents are incorporated herein by reference.

### FIELD OF THE DISCLOSURE

The present disclosure relates to toners for use in the electrophotographic (EP) process of imaging devices, such as printers, copiers, all-in-ones, multi-function devices, and the like. It relates further to toners having improved wax dispersion.

### BACKGROUND

As is familiar, the EP process includes a laser turning on and off pixels of a print job to create a latent electrostatic image of the print job on a photosensitive surface, such as a drum. A developer, by way of an adjacent doctor blade, introduces toner to the drum to create a toned image on a drum surface. A voltage differential between the drum and a transfer roll moves the toned image from the drum to a sheet of media or to an intermediate transfer member for subsequent transfer to media. Through application of heat and pressure in a nip, a fuser assembly fuses the toner to the media. It is desired that the toner readily releases from the belts or rolls of the fuser nip, exhibit minimal filming on the blade, and provide high quality media images, to name a few. Toner formulations regularly include release agents to assist in this regard, such as wax. The inventors have recognized problems with the amount, dispersion, and domain size of wax in polyester-based toner formulations and their manufacture. A need exists to overcome these and other problems.

### SUMMARY

A toner composition includes low and high molecular weight polyester resins. It also includes a release agent, such as a polyolefin wax, and a tri-block copolymer having a structure of the form A-b-B-b-A, wherein A is a hard block and B is a soft block. The hard block is styrene, while the soft block is butadiene or isoprene. Upon partial hydrogenation, the copolymer provides improved dispersion, mobility control and domain size of the release agent during fusing, for example. Additional formulations of the composition include or not colorants, iron oxide, silica, other resins, and/or charge control agents.

### DRAWING

The sole FIGURE is a chart of toner compositions according to embodiments of the present disclosure having improved wax dispersion and domain size in Examples 1-4 resulting in high fusing grade and delayed onset of blade filming (in numbers of pages) versus Comparative Examples 1-6 having poorer fusing grade and early onset of blade filming.

### DETAILED DESCRIPTION OF THE EMBODIMENTS

The toner composition includes both high and low weight molecular polyester resins. Either of the polyester resins may be understood as including polyesters having an acid value in a range from about 5 to about 50. The acid value may be due to the presence of one or a plurality of free carboxylic acid functionalities (—COOH) in the polyester resin. As used herein, an acid value references the mass of potassium hydroxide (KOH) in milligrams that is required to neutralize one gram of the polyester. The acid value is therefore a measure of the amount of carboxylic acid groups in the polyester.

The polyester resins may be also characterized as those polyesters that have a glass transition temperature (Tg) as measured by differential scanning calorimetry (DSC), wherein the onset of the shift in baseline (heat capacity) thereby indicates that the Tg may occur at about 40-80° C. at a heating rate of about 5° C. per minute (e.g., 4.75° C. per minute to 5.25° C. per minute). The midpoint value of the Tg may therefore occur at a slightly higher temperature, at about 43-83° C. Reference to a Tg value of, e.g., about 40 to about 80° C. (onset) may be also understood to include all values and increments therein as well as a variation in the observed individual Tg value of +/−1.5° C.

The polyester resins may further include those polyesters having a styrene equivalent peak molecular weight (MW) (Mp) as determined by gel permeation chromatography (GPC) of about 2500 to about 40,000. For example, the value of Mp may be about 4000-25,000, at +/−500 units. In addition, the polyesters suitable for use herein may be characterized by their molecular weight distribution (MWD) value, or weight average molecular weight (Mw) divided by the number average molecular weight (Mn). Accordingly, the polyesters herein may have a MWD of about 2 to about 30, wherein a given MWD value may be understood to vary +/−0.50. Accordingly, the MWD may have a value of about 3 to about 25, or about 4 to about 20, etc.

The polyester resins herein may therefore include those which may be characterized as having one or all of the characteristics noted above, and therefore may include linear and/or branched aliphatic and/or aromatic polyesters having the following general formulas:

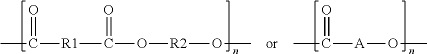

wherein R1 and/or R2 and A may be an aliphatic, aliphatic-aromatic or wholly aromatic groups and n may have a value that provides a Mp value of about 2500-40,000 as noted above. In addition, R1 and/or R2 and A may include a branch, which branching may be selected so as to provide a desired Tg value. By way of further example, the polyester herein, may be formed by the co-polycondensation polymerization of one or more carboxylic acid component comprising a carboxylic acid, an acid anhydride thereof or a lower alkyl ester thereof (for example, fumaric acid, maleic acid, maleic anhydride, phthalic acid, terephthalic acid, trimellitic acid, or pyromellitic acid), and using one or more diols such as ethylene glycol, cyclohexane dimethanol, and bisphenols (such as Bisphenol A) or a substituted compound thereof. These polyesters could comprise branched structure or could be partially cross-linked using appropriate cross-linking agents such as glycerol, which may then provide the following random copolymer units in the polyester chain:

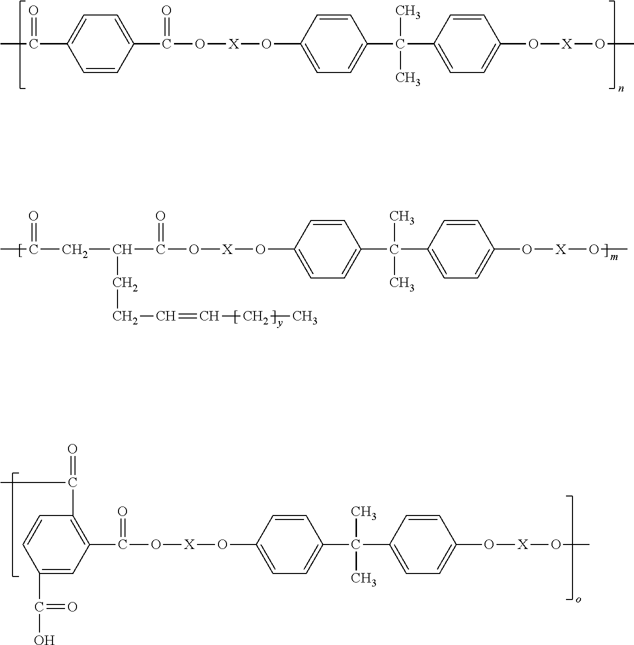

wherein n, m and o are integers which may again provide a Mp value of about 2500 to 40,000, X is an aliphatic moiety which may then provide groups such as an ethyl (—CH2CH2-) or propyl (—CH2-CH2-CH2-) group, and y may be an integer having a value of 1-20 including all values and increments therein. For example, y may have a value of 8 which would be the result of forming the above polyester from 2-dodeceny-1-yl succinic anhydride in the presence of terephthalic anhydride, trimellitic anhydride and ethoxylated or propoxylated bisphenol A. In addition, as noted above, it may be appreciated that the indicated aliphatic branch may contain residual unsaturation.

Example polyester resins include but are not limited to T100, TF-104, NE-1582, NE-701, NE-2141N, NE-1569, W-85N, NE2158N, Binder C, TPESL-10, TPESL-11, FPESL-2, FH-2, TH-24, TL-23, TL-31 and TL-17, available from Kao Corporation, Tokyo, Japan or mixtures thereof. The total polyester resin may be provided in the range of about 40% to about 95% by weight of the final toner composition. In the FIGURE, FH-2 and TL-17 represent the high and low molecular weight polyester resins, respectively. Their weight average molecular weights are less than 10,000 for the low molecular weight polyester resin and between 25,000 and 200,000 for the soluble fraction of the high molecular weight polyester resin.

Next, the toner composition includes a release agent. The release agent may include any compound that facilitates the release of toner from a component in an electrophotographic imaging device, such as release from a nip or roller surface. Representative release agents include, but are not limited to: aliphatic (C12 to C30) compounds, low molecular weight olefinic waxes such as polyethylene or polypropylene. Many natural waxes, e.g., carnuba wax, rice wax, etc., can be also used for this purpose. The inventors have found that more useful waxes have a weight average molecular weight between 400 and 2500. Further, a narrow molecular weight distribution is preferred over a broad one so that the melting point of the release agent is sharp and melts over a narrow temperature range. Release agents with a melting point of less than 130° C. are found to be suitable for this application. However, a melting point of less than 100° C. is preferred for keeping low the fusing temperature. The release agent may be provided in various amounts but has been noted as successful in the range of 1%-15%, especially between 1.5%-5% percent by weight of the entire toner composition.

Example release agents available in the current marketplace include hydrocarbon waxes (e.g., polyethylenes such as Polywax™ 400, 500, 600, 655, 725, 850, 1000, 2000 and 3000 from Baker Petrolite and polypropylenes; paraffin waxes and waxes made from CO and H2, especially Fischer-Tropsch waxes such as Paraflint™ C80 and H1 from Sasol); ester waxes, including natural waxes such as Carnuba and Montan waxes; amide waxes; and mixtures of these. Functional waxes, i.e., having functional groups, may also be used (e.g., acid functional waxes, such as those made using acidic monomers, e.g., ethylene/acrylic acid co-polymer, or grafter waxes having acid groups grafted onto the wax). The olefinic (polyethylene) (PE) wax of Examples 1-4 in the FIGURE includes Polywax™ 655.

Next, the toner composition includes a compatibilizer in the form of a styrenic block copolymer to improve dispersion, domain size and enable high content of the release agent in the toner composition. A copolymer found useful in this regard is a tri-block having a structure of the form A-b-B-b-A. The “A” part refers to the hard block or hard segment that is typically comprised of polystyrene. The “B” part refers to the soft block or soft segment that comprises poly-butadiene or poly-isoprene. The “b” simply notes the block structure. In this way, the hard styrene block is compatible with the low molecular weight polyester resin so long as the molecular weight of the styrene block is relatively low. Similarly, the soft block of butadiene or isoprene is compatible with the low molecular weight release agent. As the solubility parameter for either of the soft blocks are very close to the release agents, especially of the type polyethylene or polypropylene, they are found to be suitable for providing good dispersion of the release agent. However, excessive solubilities can interfere with the crystallization of the release agent and, if such occurs, the release agent remains in an amorphous state which adversely affects the storage properties of the toner. The inventors, therefore, partially hydrogenate the tri-block copolymer, especially the soft block, in a degree of hydrogenation in an amount from 20%-60%, with 40% having been found to be particularly useful. By limiting the degree of hydrogenation in this manner, the inventors have been able to better control the domain size of the release agent to improve fusing effectiveness.

As is known, most commercially available block compatibilizers have a total weight average molecular weight ranging from about 10,000 to 500,000, wherein styrene hard blocks range from 3000 to 100,000 while the soft blocks range from 10,000 to 200,000. The ratio of the hard block to soft block also ranges from 0.1 to 40. For this invention, the inventors have found that the better performing styrene hard blocks have a weight average molecular weight of 50,000 or less in order to find compatibility with the low molecular weight polyester resin of the toner composition. A weight average molecular weight of styrene of less than 15,000 has been found to work even better to ensure miscibility between the hard blocks and the low molecular weight polyester resin. The weight average molecular weight of the soft block, on the other hand, should be less than 50,000 to ensure that the soft blocks do not toughen the toner by acting as rubber toughening agents, which would make difficult the grinding of particles during toner manufacturing. In amounts, the tri-block copolymer may be provided in the range of about 0.5% to about 10% by weight of the entire toner composition, especially less than 5% to avoid increasing the toughness of the toner. Also, the hard blocks should exist as more than 50% of the copolymer structure in comparison to the soft block. The amount of the compatibilizer required relative to the release agent is 15%-60%, as the release agent is formulated in the toner composition.

A particularly useful tri-block copolymer used by the inventors is commercially available as Tuftec™ P2000 from Asahi Kasei, Japan. As noted in the specification sheet of the provisional application, the P2000 begins as Styrene-Butadiene-Styrene (SBS) whereupon partial hydrogenation converts it to Styrene-Butadiene/Butylene-Styrene (SBBS). The ratio of the styrene to butadiene/butylene (S/BB) exists at about 2:1, particularly 67/33. The P2000 is also the copolymer noted in the Examples 1-4 of the FIGURE. It is believed that the degree of hydrogenation noted above for the P2000 provides a balance between dispersion and mobility of the release agent during fusing the toner to media. Also, it does not affect the crystallinity of the release agent, thereby delaying filming onset.

Optionally, the toner composition includes a colorant. Colorants are compositions that impart color or other visual effects to the toner and may include carbon black, dyes (which may be soluble in a given medium and capable of precipitation), pigments (which may be insoluble in a given medium) or a combination thereof. Alternatively, a self-dispersing colorant may be used. The colorant may be present at less than or equal to about 15% by weight of the toner composition. In the examples of the FIGURE, carbon black was used as the colorant in an amount of about 6%.

Optionally still, the toner composition includes a charge control agent (CCA). Suitable charge control agents are colorless. They include (broadly) metal complexes, such as aluminum or zinc complexes, phenolic resins, etc. Examples include but are not limited to Bontron™ E84, E-84-S, E88, E89 and F21 from Orient; Kayacharge N1, N3 and N4 from Nippon Kayaku; LR147 from Japan Carlit; TN-105 from Hodogaya. The CCA may be provided in the range of about 1% to about 10% by weight of the final toner composition.

In other embodiments, the toner composition includes silica, titania, or other fumed metal oxides and/or a cleaning aid, such as iron oxide, alumina, silicon carbide, strontium titanate, or cerium oxide, especially in a range of about 0.5% to about 6% by weight of the toner composition. Iron oxide can be added to the toner composition with the silica or without the silica. If incorporated, the iron oxide is generally present in a range of about 1% to 60% by weight of the toner. In the FIGURE, the inventors used iron oxide at amounts of about 3.5%.

In still another embodiment, a hybrid resin may be introduced to the toner composition. In the FIGURE, the hybrid resin included a polyester-styrene blend having a weight average molecular weight less than 10,000 and a styrene content of the blend in an amount of less than 25% by weight. As between Examples 1, 2 and 4 where the hybrid resin was present in an amount of about 4% (especially, 4.2%), versus Example 3 when there was no hybrid resin in the toner composition, the hybrid resin was found to further improve the results. The particular hybrid resin used for Examples 1-4 was a Tuftone brand resin by the Kao Corporation.

With particular reference to the FIGURE, both Comparative Examples 1-6 and the toner composition Examples 1-4 according to embodiments of the present disclosure were prepared using the materials in the leftmost column and weighted to the specified amounts in weight percent (%) based on the total weight of the toner composition. They were prepared by adding together in batch mixer (Henschel FM-40) and blended for a brief period of time. The blended resin mixture was then added to a twin-screw extruder (Werner Pfleiderer ZSK-30) where it was melt-mixed to a homogeneous state at a temperature of 100° C. to about 200° C. followed by cooling and crushing. Next, the crushed extrudate was ground in a fluid bed jet mill (Alpine AFG-100) and classified (Matsubo Elbow-Jet air classifier) to the desired particle size, 6 μm-10 μm, preferably 7 μm-9 μm. Any desired extra particulate additives (e.g., silicas and titanias) were blended on the toner with a high-speed blender (VRIECO-NAUTA Cyclomix).

Also, all Example 1-4 compositions performed good or very good when grading fusing quality and filming onset of the doctor blade extended beyond 60,000 pages of media. Each also utilized a partially hydrogenated tri-block copolymer of the form Tuftec brand P2000. Example 2 is noted as exhibiting the best performance. In contrast, each of the comparative examples 1-6 utilized either a hydrogenated di-block copolymer or fully or non-hydrogenated tri-block copolymers. All comparative examples 1-6 suffered early onset of filming and provided merely acceptable fusing grade. Without being bound by theory, the inventors believe that a lack of a partially hydrogenated tri-block copolymer resulted in not enough wax compatibility with the polyester resins or wax having been too anchored and/or being incapable of serving as a high-performing release agent. Also, the smallest wax domains (in a range from 1.3-1.8 microns) were found with the partially hydrogenated ABA-type triblock copolymer with excellent fusing and filming performance. The esterified waxes of the comparative examples, on the other hand, had much higher non-crystalline amounts which led to poor filming performance.

For testing, the fusing evaluation of all the examples were accomplished by printing media with a line pattern or solid black on a common paper type at a common, specified temperature. The fused image was then rubbed with a white cloth for a specified number of times under a controlled load and speed. A suitable instrument for undertaking that test is a Crockmeter from Taber Industries. Next, the optical density of the cloth was measured after having been rubbed on the fused page. A higher optical density on the cloth is found to occur when more toner is removed from the test page. Higher fusing temperatures result in better fused images and subsequently, less toner is removed from the test page and a lower optical density is measured on the rubbing cloth. Toner compositions can be compared to one another by fusing printed test images at equivalent temperatures and evaluating them using the described fusing test. Again, toners that transfer less to the rubbing cloth (and measure lower optical density) are those having better fusing grades. Alternatively, the fusing evaluation can be conducted with tape-lift methodology, whereby tape is applied to the toner fused on the media to determine if and how much toner lifts off the media with the tape.

The foregoing description of several methods and example embodiments has been presented for purposes of illustration. It is not intended to be exhaustive or to limit the claims. Modifications and variations to the description are possible in accordance with the foregoing. It is intended that the scope of the invention be defined by the claims appended hereto.

1. A toner composition, comprising:
a high molecular weight polyester resin;
a low molecular weight polyester resin;
a release agent;
a tri-block copolymer having a structure of the form A-b-B-b-A, wherein A is a hard block of styrene and B is a soft block of butadiene/butylene; and
a colorant.

2. The toner composition of claim 1, wherein a weight average molecular weight of the low molecular weight polyester resin is less than 10,000

3. The toner composition of claim 1, wherein a weight average molecular weight of the high molecular weight polyester resin is between 25,000 and 200,000.

4. The toner composition of claim 1, wherein the copolymer has a weight average molecular weight of less than 100,000.

5. The toner composition of claim 1, wherein each of the hard blocks has a weight average molecular weight less than 15,000.

6. The toner composition of claim 1, wherein the soft block has a weight average molecular weight less than 50,000.

7. The toner composition of claim 1, wherein the styrene is more than 50% of the copolymer structure.

8. The toner composition of claim 1, wherein the release agent is one of an aliphatic compound and a polyolefin wax.

9. The toner composition of claim 1, wherein the release agent is a polyethylene wax with a peak melting point of less than 100° C.

10. The toner composition of claim 1, wherein a weight average molecular weight of the release agent is less than 1000.

11. The toner composition of claim 1, further including a hybrid resin having a styrene content less than 25% by weight of the hybrid resin.

12. The toner composition of claim 1, wherein a ratio of the styrene to the butadiene/butylene is about 2:1.

13. The toner composition of claim 1, wherein a domain size of the release agent ranges from about 1.3 to about 1.8 microns.

14. A toner composition, comprising:
a high molecular weight polyester resin;
a low molecular weight polyester resin;
a release agent;
a compatibilizer having a tri-block copolymer structure of the form A-b-B-b-A, wherein A is a hard block and B is a soft block; and
a colorant,
wherein a degree of hydrogenation of the soft block is between about 20% and about 60%.

15. The toner composition of claim 14, wherein the soft block is one of butadiene and isoprene.

16. The toner composition of claim 14, wherein the hard block is styrene.

17. The toner composition of claim 14, wherein the degree of hydrogenation is about 40%.

18. The toner composition of claim 14, wherein the release agent is a polyethylene wax with a peak melting point of less than 100° C.

19. The toner composition of claim 14, further including a hybrid resin having a styrene content less than 25% by weight of the hybrid resin.

20. The toner composition of claim 14, wherein a ratio of the hard block to the soft block is about 2:1.
